(19) United States
(12) Patent Application Publication
(10) Pub. No.: US 2008/0244889 A1
(43) Pub. Date: Oct. 9, 2008

(54) MOUNTING STRUCTURE AND METHOD FOR REMOVING LINEAR MEMBER

(75) Inventors: Hirofumi HAGIKURA, Susono-shi (JP); Masami Nakashima, Susono-shi (JP); Toshitaka Tezuna, Atsugi-shi (JP)

Correspondence Address: SUGHRUE-265550, 2100 PENNSYLVANIA AVE. NW, WASHINGTON, DC, 20037-3213, US

(73) Assignee: YAZAKI CORPORATION

(21) Appl. No.: 12/137,176

(22) Filed: Jun. 11, 2008

Related U.S. Application Data
(62) Division of application No. 11/745,474, filed on May 8, 2007.

(30) Foreign Application Priority Data
May 10, 2006 (JP) P2006-131148

(51) Int. Cl. B23P 19/00

(52) U.S. Cl. 29/426.5

(57) ABSTRACT

A mounting structure includes a mounting member, and a connecting terminal which is fixed to the mounting member by a first fixing force. A linear member is fixed to the connecting terminal by a second fixing force. The second fixing force is smaller than the first fixing force.

This is a divisional of application Ser. No. 11/745,474 filed May 8, 2007. The entire disclosure of the prior application, application Ser. No. 11/745,474 is considered part of the disclosure of the accompanying divisional application and is hereby incorporated by reference.

### BACKGROUND OF THE INVENTION

The present invention relates to, for example, a mounting structure in which an earth terminal to which an electric wire is clamped is fixed to a vehicle body panel.

Recently, in a mounting structure of this type, in order to enhance the easy disassembly of electric wires, a breaking groove (an easy breakable portion, a breaking portion) was formed in a connecting terminal. Then, at the disassembly of a vehicle body, the connecting terminal was broken into two halves at the breaking groove so as to remove the electric wires from the vehicle body without removing fixing devices (for example, refer to Patent Document Nos. 1, 2).

### [Patent Document No. 1] JP-A-2003-178824

### [Patent Document No. 2] JP-A-2003-203687

However, with those related mounting structures, there are the following problems.

Firstly, an electric passage is narrowed by the formation of the breaking groove, and the electric resistance value is inevitably increased in inverse proportion to the reduction in sectional area.

Secondarily, since the breaking force is determined mainly by the depth of the breaking groove (the thickness of a residual portion of the connecting terminal), where the breaking force of the connecting terminal is set low, the resulting structure tends to call for a factor which triggers scattering in production and hence becomes difficult to be adopted for products for mass production.

### SUMMARY OF THE INVENTION

The invention is made in view of the situations and an object thereof is to provide a mounting structure and a linear member removing method which can solve the problems described above as inherent in the related art.

According to the present invention, there is provided a mounting structure, comprising:

a mounting member;

a connecting terminal which is fixed to the mounting member by a first fixing force; and

a linear member which is fixed to the connecting terminal by a second fixing force,

wherein the second fixing force is smaller than the first fixing force.

Preferably, the linear member is thermocompression bonded to the connecting terminal by the second fixing force.

Preferably, the linear member is clamped to the connecting terminal by the second fixing force.

Preferably, the linear member is thermocompression bonded by a predetermined thermocompression boding force and is clamped to the connecting terminal by a predetermined clamping force. The second fixing force is a sum of the predetermined thermocompression boding force and the predetermined clamping force.

According to the present invention, there is also provided a method for removing a linear member from a connecting terminal, comprising:

providing a mounting structure in which the linear member is thermocompression bonded to a thermocompression bonding surface of the connecting terminal, the connecting terminal being fixed to a mounting member; and

stripping off the linear member from the connecting terminal by pulling the linear member in a direction which intersects the thermocompression bonding surface.

When used herein, the clamping force means a force by which the linear member (such as an electric wire) is clamped by the connecting terminal (such as an earth terminal). In addition, the thermocompression bonding force means a force by which the linear member is thermocompression bonded to the connecting terminal. Furthermore, the fixing force means a force by which the connecting terminal is fixed to the mounting member (such as a vehicle body panel).

According to the invention, even though the connecting terminal (such as an earth terminal) is fixed to the mounting member (such as a vehicle body panel) by fixing devices (such as bolts and nuts), at the disassembly of the vehicle or the like, the linear member can easily be removed from the mounting member by stripping off the linear member (such as an electric wire) without removing the fixing devices.

In addition, since the formation of a breaking groove in the connecting terminal is unnecessary, the problem can be avoided that the electric resistance value is increased when energized.

Furthermore, to set the removing force of the linear member low, the clamping force and the thermocompression bonding force only have to be weakened. Consequently, even in the event that the removing force of the linear member is set low, the resulting structure is difficult to call for the factor which triggers scattering in production and hence can easily be adopted for products for mass production.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view showing a first embodiment of a mounting structure according to the invention;

FIG. 2 is a plan view of the mounting structure shown in FIG. 1;

FIG. 3 is a perspective view of a vehicle body panel of the mounting structure shown in FIG. 1;

FIGS. 4A and 4B are a plan view and a front view of an earth terminal of the mounting structure shown in FIG. 1;

FIG. 5 is a front view showing a first step of a linear member removing method according to the invention;

FIG. 6 is a front view showing a second step of the linear member removing method according to the invention;

FIG. 7 is a front view showing a third step of the linear member removing method according to the invention;

FIG. 8 is a plan view showing an earth terminal of a second embodiment of a mounting structure of the invention; and

FIGS. 9A, 9B and 9C are drawings showing an earth terminal of a third embodiment of a mounting structure of the invention, wherein FIG. 9A is a plan view of the earth terminal, FIG. 9B is a right side view thereof, and FIG. 9C is a front view thereof.

### DETAILED DESCRIPTION OF THE PREFERRED EMBODIMENTS

Hereinafter, embodiments of the invention will be described based on the accompanying drawings.

### First Embodiment

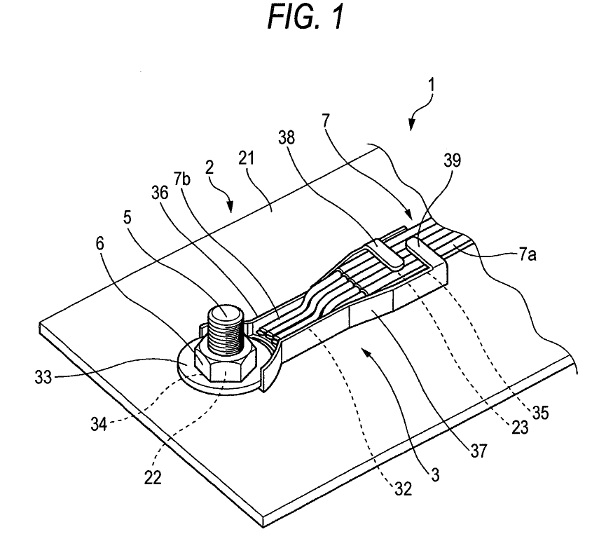

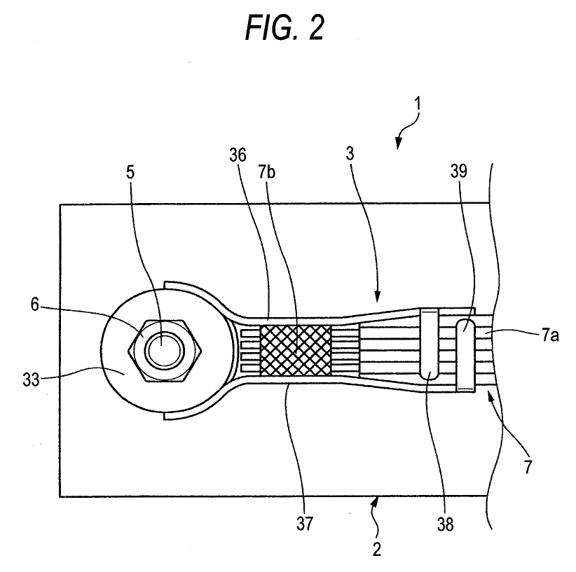

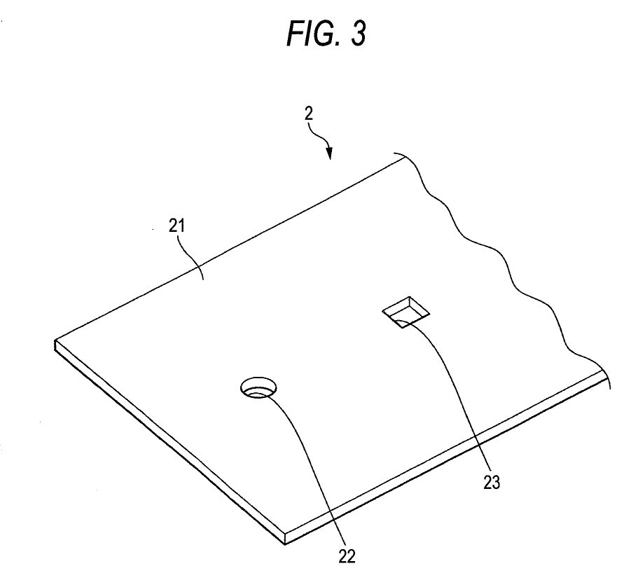

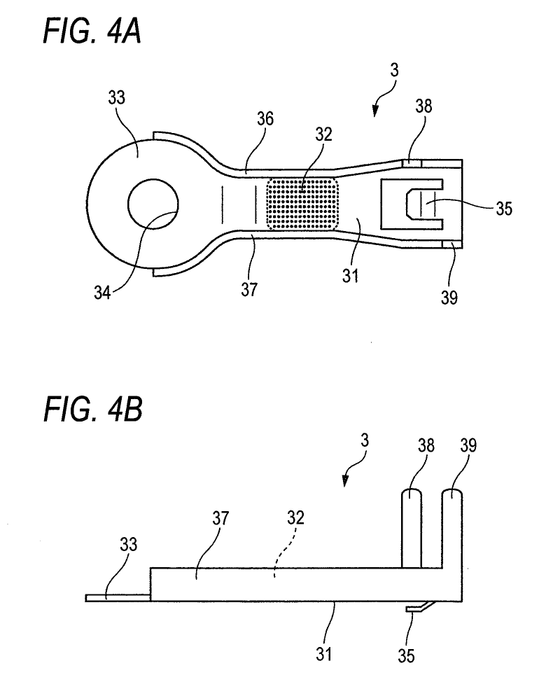

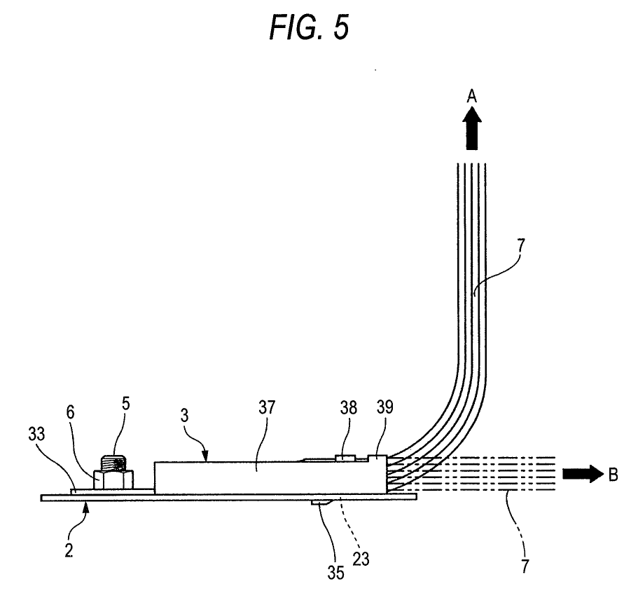

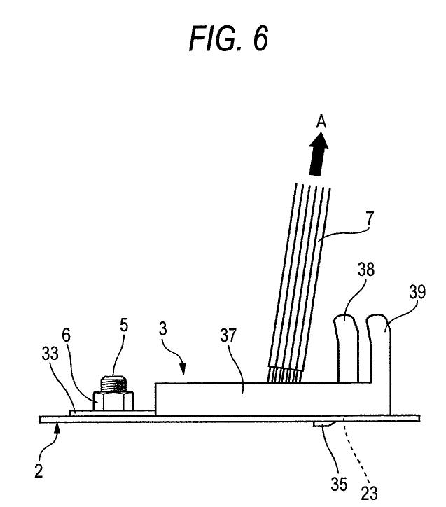

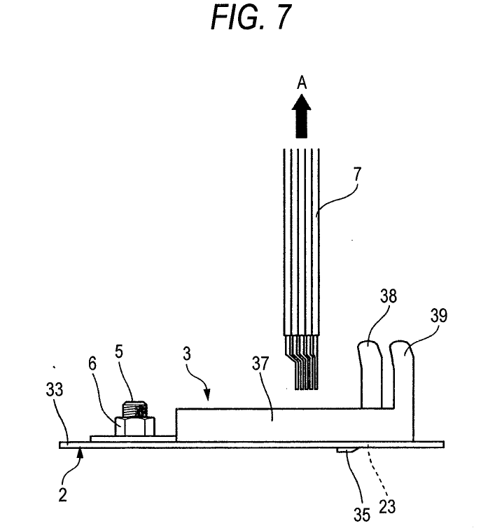

Fig. is a perspective view which shows a first embodiment of a mounting structure according to the invention, FIG. 2 is a plan view of the mounting structure shown in FIG. 1, FIG. 3 is a perspective view of a vehicle body panel of the mounting structure shown in FIG. 1, FIGS. 4A and 4B are a plan view and a front view of an earth terminal of the mounting structure shown in FIG. 1, FIG. 5 is a front view showing a first step of a linear member removing method according to the invention, FIG. 6 is a front view showing a second step of the linear member removing method according to the invention, and FIG. 7 is a front view showing a third step of the linear member removing method according to the invention.

A mounting structure includes, as is shown in FIGS. 1 and 2, a vehicle body panel (a mounting member) 2. An earth terminal (a connecting terminal) 3 is fixed to the vehicle body panel 2 through bolt fastening and claw or click engagement, and electric wires (a linear member) 7 are mounted on the earth terminal 3 through thermocompression bonding and clamping.

Namely, as is shown in FIG. 3, the vehicle body panel 2 has a flat plate-like panel main body 21, and a circular bolt passage hole 22 and a rectangular terminal engagement hole 23 are formed in the panel main body 21.

In addition, as is shown in FIG. 4A, the earth terminal 3 has a substantially rectangular terminal main body 31, and a thermocompression bonding surface 32 is formed at a central portion of the terminal main body 31. In addition, an annular fastening portion 33 is formed in one end (a left end as viewed in FIG. 4A) of the terminal main body 31, and a circular vehicle body mounting hole 34 is formed in a central portion of the fastening portion 33. Additionally, a vehicle body fixing claw 35 is formed by being cut to erect from the terminal main body 31 at the other end thereof in such a manner as to be directed obliquely downwards and then towards the vehicle body mounting hole 34 in a step-like fashion. Furthermore, ribs 36, 37 are provided on both sides of the terminal main body 31, respectively, in such a manner as to erect therefrom, and electric wire clamping claws 38, 39 are provided on the ribs 36, 37, respectively, in such a manner as to erect therefrom in positions in the vicinity of the vehicle body fixing claw 35 which deviate from each other in a longitudinal direction (a horizontal direction as viewed in FIGS. 4A and 4B) of the terminal main body 31.

Then, as is shown in FIGS. 1 and 2, a bolt 5 is passed through the vehicle body mounting hole 34 and the bolt passage hole 22 in the vehicle body panel 2, a nut 6 is then screwed on to the bolt 5 and the vehicle body fixing claw 35 is hooked in a terminal engagement hole 23 in the vehicle body panel 2 for engagement therewith, whereby the earth terminal 3 is fixed to the vehicle body panel 2. In addition, the electric wires 7 are clamped on their sheathing portions 7a by the electric wire clamping claws 38, 39, and bare thermocompression bonding portions 7b are thermocompression bonded to the thermocompression bonding surface 32 of the earth terminal 3 for energization, whereby the electric wires 7 are mounted on the earth terminal 3. As a specific method for carrying out this thermocompression bonding of the electric wires 7, a known method disclosed in, for example, JP-A-6-132041 can be adopted.

Note that on the earth terminal 3, the clamping force and the thermocompression bonding force are set weaker than the fixing force. Here, the clamping force means a force by which the earth terminal 3 clamps the electric wires 7 by the electric wire clamping claws 38, 39. In addition, the thermocompression bonding force means a force by which the electric wires 7 are thermocompression bonded to the thermocompression bonding surface 32 of the earth terminal 3. Furthermore, the fixing force means a force by which the earth terminal 3 is fixed to the vehicle body panel 2 by the vehicle body fixing claw 35.

Since the mounting structure 1 has the configuration that has been described heretofore, when removing the electric wires 7 from the vehicle body 2 at the time of disassembly of the vehicle or replacement of electric wires 7, the following procedure is to be taken.

Firstly, as is shown in FIG. 5, the electric wires 7 are bent almost to right angles, so as to be stripped off in a direction which intersects the thermocompression bonding surface 32 of the earth terminal 3 at right angles (a direction indicated by an arrow A). Then, on the earth terminal 3, a force is applied to the electric wire clamping claws 38, 39 in the direction indicated by the arrow A, and at the same time, a force is applied to the vehicle body fixing claw 35 in an opposite direction. As this occurs, as has been described above, on the earth terminal 3, since the clamping force is weaker than the fixing force, as is shown in FIG. 6, the two electric wire clamping claws 38, 39 are opened while the vehicle body fixing claw 35 remains in engagement with the terminal engagement hole 23 in the vehicle body panel 2.

When the two electric wire clamping claws 38, 39 are forced to be opened in this way, then, a tensile force is applied to the thermocompression boding portions 7b of the electric wires 7 in the direction indicated by the arrow A. Then, a force in the direction indicated by the arrow A is applied to the earth terminal 3 as while being drawn by the electric wires 7, and at the same time, a force in an opposite direction is applied to the vehicle body fixing claw 35. As this occurs, as has been described above, on the earth terminal 3, since the thermocompression boding force is weaker than the fixing force, as is shown in FIG. 7, the thermocompression boding portions 7b are stripped off from the earth terminal 3 while the vehicle body fixing claw 35 remains in engagement with the terminal engagement hole 23 in the vehicle body panel 2.

Note that since the thermocompression boding portions 7b are drawn in the direction indicated by the arrow A, that is, the direction which intersects the thermocompression bonding surface 32 of the earth terminal 3 at right angles, the thermocompression bonding portions 7b can be stripped off by a force weaker than when they are drawn in a direction indicated by an arrow B or a direction which is parallel to the thermocompression boding surface 32, that is, in a direction which runs parallel to the thermocompression bonding surface 32.

Here, the removing work of the electric wires 7 ends.

Thus, the mounting structure 1 is superior in the easy disassembly of the electric wires 7, and hence, the electric wires 7 can easily be removed from the vehicle body panel 2 without removing the bolt 5 and the nut 6 which attach the earth terminal 3 on to the vehicle body panel 2 or without using a heavy machine.

Moreover, being different from the conventional method in which the earth terminal 3 is broken into two halves, according to the invention, even when the electric wires 7 are removed, there occurs no case where part of the earth terminal 3 is removed together with the electric wires 7. Consequently, the electric wires 7 which were removed from the vehicle body panel 2 can be recycled as they are for reuse.

In addition, being different from the conventional method in which the breaking groove is formed on the earth terminal 3, according to the invention, since no working is given to the earth terminal 3 to narrow the electric passage, the problem can be avoided that the electric resistance value is increased when energized.

Furthermore, in order to set low the removing force of the electric wires 7, the clamping force and thermocompression bonding force of the earth terminal 3 only have to be weakened. Consequently, even in the event that the removing force of the electric wires 7 is set low, the mounting structure of the embodiment calls for no factor which triggers scattering of production and hence can easily be applied to products for mass production.

### Second Embodiment

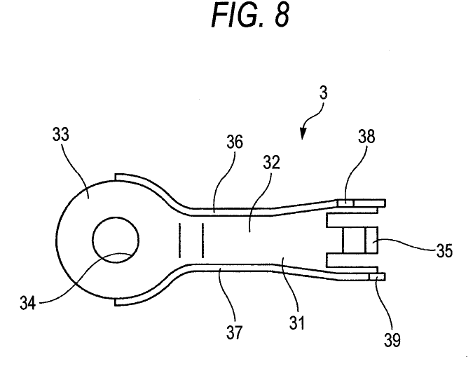

FIG. 8 is a plan view showing an earth terminal of a second embodiment of a mounting structure according to the invention.

While in the first embodiment, the vehicle body fixing claw 35 is described as being formed in such a manner as to be directed towards the vehicle body mounting hole 34, the orientation of the vehicle body fixing claw 35 is not limited to being directed toward the vehicle body mounting hole 34. For example, as is shown in FIG. 8, the vehicle body fixing claw 35 may be formed in such a manner as to be directed to an opposite direction to the vehicle body mounting hole 34.

### Third Embodiment

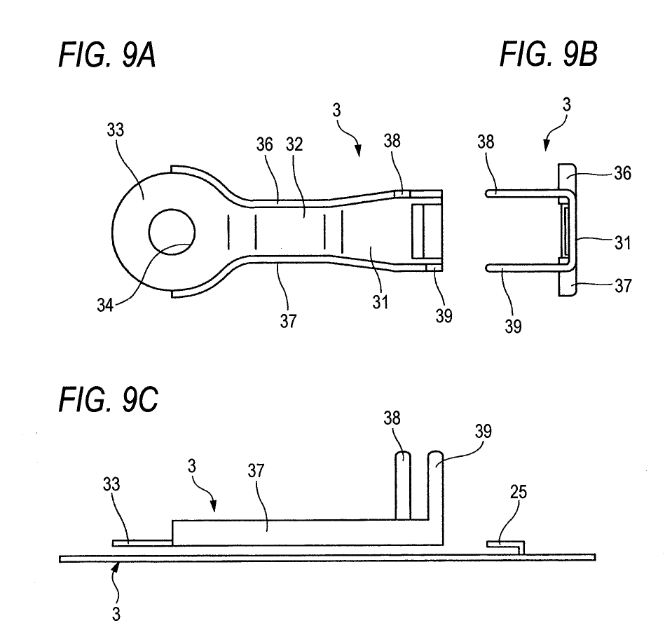

FIGS. 9A, 9B and 9C are drawings showing an earth terminal of a third embodiment of a mounting structure according to the invention, wherein FIG. 9A is a plan view of the earth terminal, FIG. 9B is a right side view thereof, and FIG. 9C is a front view thereof.

While in the embodiments that have been described above, the invention is described as being applied to the earth terminal 3 on which the vehicle body fixing claw 35 is formed, in stead of forming the vehicle body fixing claw 35 on the earth terminal 3, there would be caused no problem even when a terminal fixing claw 25 is formed on the side of the vehicle body panel 2, as is shown in FIG. 9C. In this case, a fixing force means a force by which the earth terminal 3 is fixed to the vehicle body panel 2 by the terminal fixing claw 25.

### Other Embodiments

While in the embodiments that have been described heretofore, the electric wires 7 are described as being stripped off in the direction which intersects the thermocompression bonding surface 32 of the earth terminal 3 at right angles when the electric wires 7 are removed from the vehicle body panel 2, the electric wires 7 only have to be stripped off in a direction which intersects the thermocompression bonding area 32 of the earth terminal 3, and hence, the direction in which the electric wires 7 are drawn does not necessarily have to intersect the thermocompression bonding surface 32 of the earth terminal 3 at 90 degrees.

While in the above embodiments, the electric wires 7 are mounted on the earth terminal 3 through thermocompression bonding and clamping, the electric wires 7 may be mounted on the earth terminal 3 only through thermocompression bonding or only through clamping.

While in the above embodiments, the earth terminal 3 is mounted on the vehicle body panel 2, the invention can be applied to mounting members other than the vehicle body panel 2 (such as a box for an electronic unit or units. As this occurs, a fixing force means a force by which the earth terminal 3 is fixed to such a mounting member by the vehicle body fixing claw 35.

While in the above embodiments, the invention is described as being applied to the earth terminal 3 provided with the annular fastening portion 33, the invention can be applied to earth terminals 3 provided with a hook type fastening portion and a fork type fastening portion, respectively. Furthermore, the invention can be applied to other connecting terminals than the earth terminal 3 (such as connecting terminals in which fastening is implemented through forced fitting, press fitting and the like). As this occurs, a clamping force means a force by which the electric wires 7 are clamped by the connecting terminal. In addition, a thermocompression bonding force means a force by which the electric wires 7 are thermocompression bonded to the connecting terminal. Furthermore, a fixing force means a force by which the connecting terminal is fixed to the vehicle body panel 2.

While in the above embodiments, the invention is described as being applied to the mounting structure 1 of the electric wires 7, the invention can be applied to other linear members than the electric wires 7 (such as FFC (flexible flat cable), flat electric wires and other various types of electric wires). As this occurs, a clamping force means a force by which the linear members are clamped by the electric wire clamping claws 38, 39 of the earth terminal 3.

The invention can be broadly applied to various types of industrial fields including automobiles, airplanes, electric trains, production plants, electric appliances, OA equipment and the like.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2006-131148 filed on May 10, 2006, the contents of which are incorporated herein for reference.

What is claimed is:

1. A method for removing a linear member from a connecting terminal, comprising:
providing a mounting structure in which the linear member is thermocompression bonded to a thermocompression bonding surface of the connecting terminal, the connecting terminal being fixed to a mounting member; and
stripping off the linear member from the connecting terminal by pulling the linear member in a direction which intersects the thermocompression bonding surface.
